(19) United States
(12) Patent Application Publication
(10) Pub. No.: US 2022/0335476 A1
(43) Pub. Date: Oct. 20, 2022

(54) METHOD AND SYSTEM FOR PROVIDING INTERACTIVE PERSONALIZED IMMERSIVE CONTENT

(71) Applicant: AT&T Intellectual Property I, L.P., Atlanta, GA (US)

(72) Inventors: Mohammed Abdel-Wahab, Madison, NJ (US); Tan Xu, Bridgewater, NJ (US); Eric Zavesky, Austin, TX (US); Louis Alexander, Franklin, NJ (US); Richard Palazzo, Stewartsville, NJ (US)

(73) Assignee: AT&T Intellectual Property I, L.P., Atlanta, GA (US)

(21) Appl. No.: 17/234,899

(22) Filed: Apr. 20, 2021

(51) Int. Cl. G06Q 30/02; G06F 3/01

(52) U.S. Cl. CPC G06Q 30/0271; G06Q 30/0261; G06Q 30/0255; G06Q 30/0277; G06F 3/011; G06F 3/017

(57) ABSTRACT

Aspects of the subject disclosure may include, for example, obtaining contextual information relating to a user, where the contextual information comprises location data that identifies a location of the user, identifying media content that relates to the contextual information and to profile data associated with the user, deriving, from the media content, personalized media content based on the profile data associated with the user, causing a target device to provide an immersion environment that includes the personalized media content, detecting user interaction data relating to the immersion environment, and performing an action relating to the personalized media content based on the detecting the user interaction data. Other embodiments are disclosed.

### FIELD OF THE DISCLOSURE

The subject disclosure relates to providing interactive personalized immersive content.

### BACKGROUND

As technology continues to advance, more products and systems that provide immersive experiences (e.g., via extended reality (XR), such as augmented reality (AR), virtual reality (VR), or mixed reality (MR)) are being developed.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIGS. 2B-2D are diagrams illustrating example, non-limiting immersive experiences provided by the system of FIG. 2A in accordance with various aspects described herein.

FIG. 2E is a high-level functional block diagram of a system functioning within, or operatively overlaid upon, the communications network of FIG. 1 in accordance with various aspects described herein.

FIG. 2F depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

Current technologies that provide immersive experiences (e.g., based on geofencing and/or via extended reality (XR), such as augmented reality (AR), virtual reality (VR), or mixed reality (MR)) generally offer static or predefined content with no personalization of content renderings. Furthermore, present immersion technologies do not allow for user interactivity and lack the capability to provide additional real-world impact for a user based on such interactivity.

Exemplary embodiments described herein provide an immersive content platform that is capable of enhancing immersive experiences—e.g., in XR or two-dimensional (2D) digital domains—with location-based and/or personalized content (or asset) renderings. In various embodiments, the immersive content platform can be configured to obtain contextual information relating to a user (e.g., primary cues or triggers, such as location data that identifies a location of the user, data regarding a media content item that the user has requested or is currently consuming, calendar data associated with the user, travel-related data associated with the user, voice-based input data associated with the user, gesture-based input data associated with the user, time of day information, weather information, etc.), and identify media content that relates to the contextual information and to profile data associated with the user. The profile data may be used as personalization cues or triggers, and may include information regarding preferences of the user, interests of the user, a browsing history of the user, a media consumption history of the user, a purchase history of the user, an advertising response history of the user, historical immersion-related behavior of the user, etc. In some embodiments, the immersive content platform may derive, from the media content, personalized media content based on the profile data, and cause one or more target device(s) (e.g., a smartphone, a smartwatch, an XR-based user equipment (e.g., a headset, a pair of glasses, headphones, etc.), and/or one or more proximal devices, such as proximal displays, proximal speakers, etc.) to provide an immersion environment that includes the personalized media content. The personalized media content may include audio content, image content, video content, XR object(s), etc. For example, the personalized media content may include, or relate to, a scene from a film or television show (e.g., a reenactment thereof), a song, a video clip, a person or character (e.g., represented by a three-dimensional (3D) representation, such as an avatar), a brand, a branded product, and/or the like. In certain embodiments, the immersive content platform may detect user interaction data (e.g., information regarding movements of the user, gestures of the user, voice-based inputs of the user, etc.) relating to the immersion environment, and perform action(s) relating to the personalized media content based on the user interaction data. Examples of such action(s) may include recording the personalized media content and/or the user interaction data (e.g., in a media content library associated with the user, in a general archive, and/or the like) for future playback, sharing the personalized media content and/or the user interaction data with one or more other users associated with the user, associating the personalized media content and/or the user interaction data with the location of the user for future use (e.g., in an immersion associated with a different user, etc.), facilitating a reservation for a service for the user, facilitating a purchase of a product for the user, scheduling a service appointment for the user, facilitating additional media location guidance (e.g., presenting data or content associated with additional follow-up activities at a subsequent location), etc.

Embedding location-based and/or personalized content renderings in immersion environments, as described herein, provides a deeper level of immersion and a robust entertainment experience for a user, and also allows for rediscovery and/or reuse of historical assets (e.g., that the user may have previously consumed) as well as other assets that may be previously unknown to the user. Embedding media content or assets (in an immersion or otherwise) based on user profile data or the like, as described herein, broadens marketing channels, avoids a need to explicitly query users for their content preferences, and personalizes immersive experiences—e.g., enables user discovery of location context and consumption of media content (e.g., for entertainment purposes, for educational purposes, for socializing purposes, etc.) that the user may not have considered or may not have been unaware of. Providing interactive immersive content that allows for in-painting of content and/or that includes user-engageable triggers or interaction hooks (e.g., hooks included in media content by content creators/authors and/or identified, by the immersive content platform, based on presence of objects, characters, etc. in media content) that, when activated by a user, trigger/result in adjustments to media content, presentation of other media content, follow-up activities, etc., as described herein, promotes user engagement and also provides new venues for advertising. Facilitating a follow-up activity, such as recording a user's custom interactions with media content at a particular location, as described herein, also enables sharing of such recordings with other users who visit the particular location at a later point, which can further promote user/social engagement. Further, facilitating a follow-up activity, such as a purchase request, a reservation, scheduling of an appointment, etc., as described herein, enables bridging of immersion-related actions or events with practical real-world activities, which can also enhance overall user experience.

The subject disclosure describes, among other things, illustrative embodiments for identifying, generating, and/or providing of interactive, personalized media content based on contextual information and user profile data. Other embodiments are described in the subject disclosure.

One or more aspects of the subject disclosure include a device, comprising a processing system including a processor, and a memory that stores executable instructions that, when executed by the processing system, facilitate performance of operations. The operations can include obtaining contextual information relating to a user, where the contextual information comprises location data that identifies a location of the user. Further, the operations can include identifying media content that relates to the contextual information and to profile data associated with the user, deriving, from the media content, personalized media content based on the profile data associated with the user, causing a target device to provide an immersion environment that includes the personalized media content, detecting user interaction data relating to the immersion environment, and performing an action relating to the personalized media content based on the detecting the user interaction data.

One or more aspects of the subject disclosure include a non-transitory machine-readable medium, comprising executable instructions that, when executed by a processing system including a processor, facilitate performance of operations. The operations can include providing, to an immersive content platform, contextual information relating to a user, where the contextual information comprises location data that identifies a location of the user. Further, the operations can include, responsive to the providing the contextual information to the immersive content platform, obtaining, from the immersive content platform, immersion data to be rendered, where the immersion data includes personalized media content derived according to profile data associated with the user. Further, the operations can include rendering the immersion data to provide the personalized media content in an immersion environment, detecting a user interaction relating to the immersion environment, and based on the detecting the user interaction, transmitting user interaction data to the immersive content platform to enable the immersive content platform to perform a follow-up action relating to the personalized media content.

One or more aspects of the subject disclosure include a method. The method can include receiving, by a processing system including a processor, contextual information regarding a user, where the contextual information comprises location data that identifies a location of the user. Further, the method can include identifying, by the processing system, media content that relates to the contextual information and to profile data associated with the user, generating, by the processing system and from the media content, personalized media content adapted to promote user interaction, causing, by the processing system, a plurality of target devices to provide an immersion environment that includes the personalized media content, detecting, by the processing system, user interaction data relating to the immersion environment, and based on the user interaction data, performing an action relating to the personalized media content.

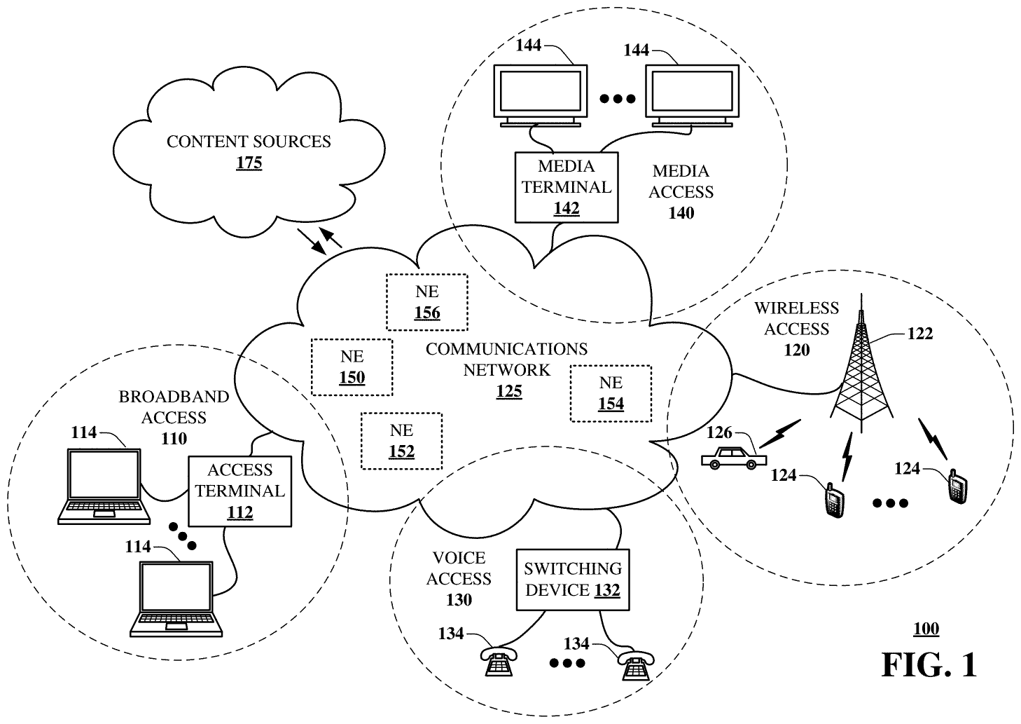

Referring now to FIG. 1, a block diagram is shown illustrating an example, non-limiting embodiment of a system 100 in accordance with various aspects described herein. For example, system 100 can facilitate, in whole or in part, identifying, generating, and/or providing of interactive, personalized media content based on contextual information and user profile data. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

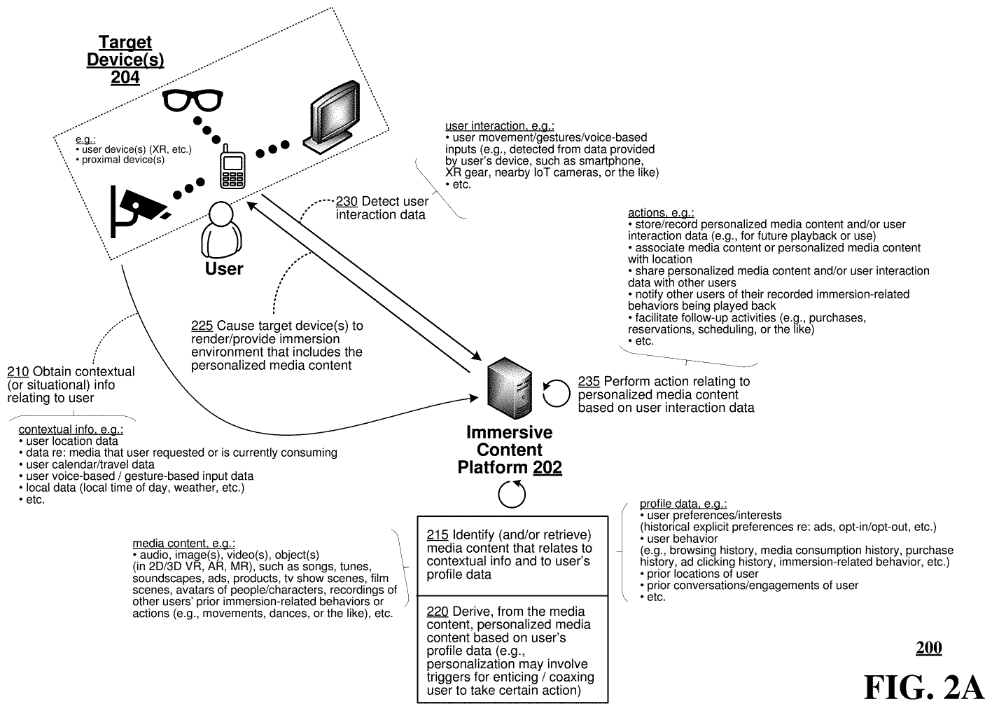

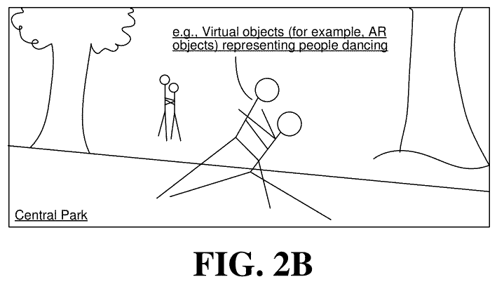

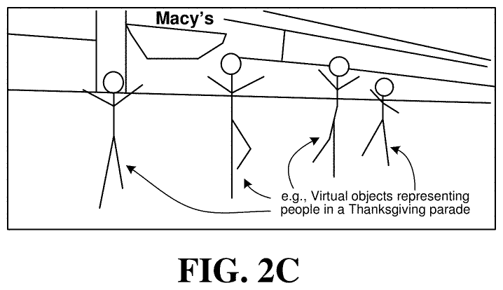

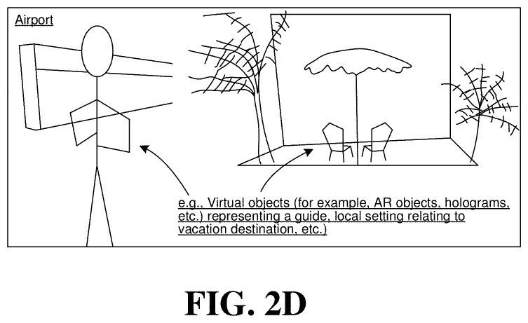

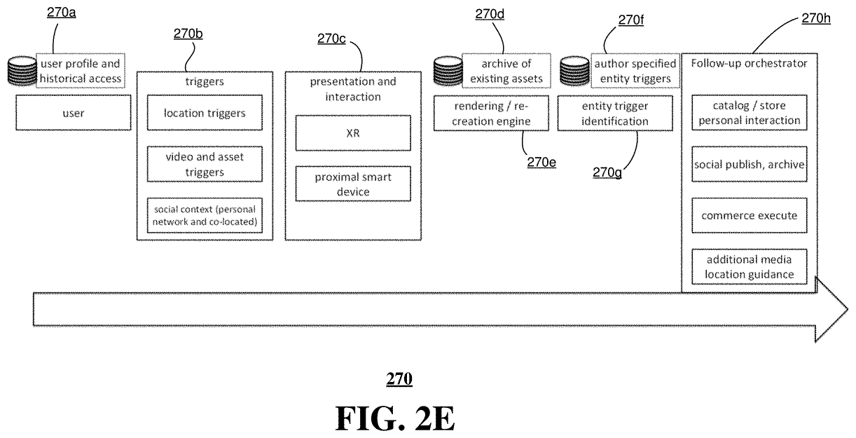

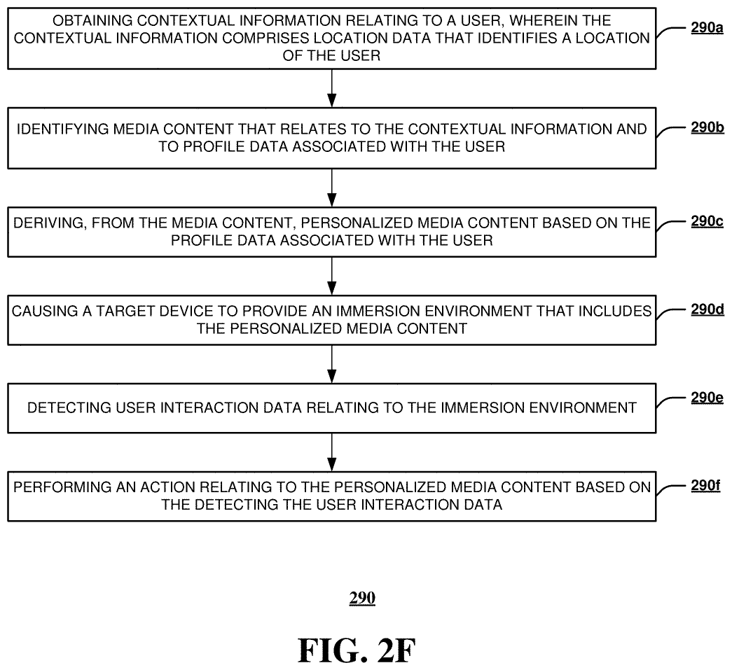

FIG. 2A is a block diagram illustrating an example, non-limiting embodiment of a system 200 functioning within, or operatively overlaid upon, the communications network of FIG. 1 in accordance with various aspects described herein.

As shown in FIG. 2A, the system 200 can include an immersive content platform 202. The immersive content platform 202 can include one or more devices (e.g., server device(s) or the like) configured to provide one or more functions or capabilities, such as identifying, generating, and/or providing interactive, personalized media content based on contextual information and user profile data.

As shown in FIG. 2A, the immersive content platform 202 may be communicatively coupled to one or more target (or client) devices 204. The target device(s) 204 may include one or more devices capable of receiving, generating, storing, processing, and/or providing data (e.g., audio data, video data, XR data, text data, control data, etc.) relating to the immersive content platform 202. For example, a target device 204 can include a communication and/or computing device, such as a mobile phone (e.g., a smart phone, a radiotelephone, etc.), a desktop computer, a laptop computer, a tablet computer, a handheld computer, a display device, a gaming device, a wearable communication device (e.g., a smart wristwatch, a pair of smart eyeglasses, XR gear (e.g., a pair of AR, VR, MR glasses, a headset, headphones, and/or the like), etc.), or a similar type of device.

Although not shown, in some embodiments, the immersive content platform 202 may be communicatively coupled to the target device(s) 204 via a network. The network may include one or more wired and/or wireless networks. For example, the network may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

It will be appreciated and understood that the system 200 can include any number of immersive content platforms, target devices, and networks, and thus the number of immersive content platforms, target devices, and networks shown in FIG. 2A is for illustrative purposes only.

As shown by reference number 210, the immersive content platform 202 may obtain contextual (or situational) information relating to a user. In some embodiments, the contextual information may be related to people, objects, and/or events occurring in proximity to, or associated with, the user.

In various embodiments, the contextual information may include data regarding a location of the user, data regarding a media content item (e.g., video, audio, etc.) that the user has requested or is presently consuming, calendar/travel-related data associated with the user, data regarding a voice-based input provided by the user, data regarding a gesture-based input provided by the user, data regarding a present time of day, weather data, data regarding structures (e.g., buildings or other objects) at or near the location, and/or the like.

In some embodiments, data regarding a location of the user may include global positioning system (GPS) coordinates or the like provided by one or more of the target device(s) 204, such as a smartphone or a smartwatch of the user. In certain embodiments, data regarding a location of the user may be based on facial recognition and/or detection data provided by one or more of the target device(s) 204, such as a camera system (e.g., an Internet-of-Things (IoT) camera or the like) positioned at a known location. In one or more embodiments, data regarding a location of the user may include information relating to a communication session (e.g., a Wi-Fi connection, a Bluetooth connection, a near field communication (NFC) connection, and/or the like) established between a network/device (e.g., registered with or otherwise known to the immersive content platform 202) and one or more of the target device(s) 204, such as a smartphone or a smartwatch of the user.

In various embodiments, data regarding a media content item that the user has requested or is presently consuming may include a title of the media content item, a description of the media content item, information regarding a source of the media content item, and/or information regarding a determined fingerprint of audio/video in the media content item provided by one or more of the target device(s) 204, such as a smartphone, a smartwatch, a video/audio player, an audio/video fingerprinting device/service, etc. associated with the user.

In certain embodiments, calendar/travel-related data may identify the user's current/upcoming schedule and/or travel route, and may be provided by one or more of the target device(s) 204, such as a smartphone or a smartwatch of the user, or otherwise obtained from a user account accessible to the immersive content platform 202.

In one or more embodiments, data regarding a voice-based user input may relate to a user utterance or command, and may be provided by one or more of the target device(s) 204, such as a smartphone or a smartwatch of the user. In some embodiments, data regarding a gesture-based input may include information regarding movements of the user's body (e.g., legs, arms, hands, fingers, etc.), and may be provided by one or more of the target device(s) 204, such as a smartphone, a smartwatch, a camera system (e.g., an IoT camera or the like), etc.

In various embodiments, the immersive content platform 202 may be configured to determine a likely mood of the user based on a present time of day, weather information, genre of music that the user is currently consuming, the user's voice-based inputs, the user's gesture-based inputs, and/or the like. For example, the immersive content platform 202 may determine whether a user is feeling neutral, jolly, agitated, nervous, etc. based on voice-based inputs, such as utterances made by the user in a neutral manner, a jolly manner, an agitated manner, a nervous manner, etc. and/or based on gesture-based inputs, such as the user assuming a neutral bodily pose, throwing the user's arms up, walking slowly or hurriedly, etc.

As shown by reference number 215, the immersive content platform 202 may identify (and/or retrieve) media content that relates to the contextual information and to profile data associated with the user.

In various embodiments, the profile data can include data relating to user preferences (e.g., historical explicit preferences, including advertisement placement policy restrictions, opt-in or opt-out preferences, or the like), data relating to user behaviors and/or interests (e.g., historical behaviors, such as Internet browsing activities, content consumption (e.g., videos, games, etc.), purchase histories, and/or the like), demographic data associated with the user (e.g., age of the user, gender of the user, etc.), and/or the like. In some embodiments, the profile data can additionally, or alternatively, include data relating to prior locations of the user (e.g., places that the user has visited, performances/shows/conferences that the user has attended, etc.), which may, for example, be determined based on historical location (e.g., GPS) data, based on Exif (Exchangeable image file) data from photos previously captured by a camera of the user's smartphone, based on historical calendar data, etc.

In certain embodiments, the profile data can additionally, or alternatively, include data relating to prior conversations, discussions, and/or engagements of the user, data relating to advertisement responses of the user (e.g., advertisement exposures, click-through actions, affinities between users and advertisements and/or advertisement types) and/or other data representative or indicative of user activities, preferences, and/or behaviors (e.g., Interactive Advertising Bureau (IAB)-related data, tag data, genre data, embedding data, and/or the like). In one or more embodiments, the profile data can include XR domain data, such as data relating to user behavior in immersion environments (e.g., user activities or interactions associated with objects in immersion environments, including objects that are native to the immersion environment and/or advertising objects included, or embedded, in the immersion environment).

In some embodiments, the profile data may include social profile information associated with the user (e.g., the user's social media/networking profile). In certain embodiments, the social profile information may include data regarding actions, preferences, activities, and/or the like relating to the user's friends, family, or other connections, such as other users that the user may be following, etc.

It is to be appreciated and understood that some data/information described as being contextual information may instead be characterized as profile data, and vice versa. For example, in some embodiments, the above-described social profile information may be characterized as contextual information.

In various embodiments, the media content may include audio content (e.g., stereo audio, surround sound, binaural audio, 3D audio, etc.), such as a song, a tune, a speech, a soundscape, and/or the like. In some embodiments, the media content may include image/video/object content (e.g., video clips, graphics, computer-generated objects, etc., which may, for example, include 2D/3D VR, AR, MR objects or the like). In certain embodiments, the media content may include, or relate to, a scene from a film or television show, a recording of an event (e.g., a concert, a sports competition, etc.), people/characters (e.g., represented by virtual objects, such as avatars), a product to be marketed or advertised, etc.

The immersive content platform 202 may identify and/or obtain media content from any suitable source, such as publicly available database(s), private database(s), the user's personal library or collection, and/or the like. It is to be appreciated and understood that the media content may include content that the user may or may not be previously aware of.

In exemplary embodiments, the immersive content platform 202 may identify and/or retrieve media content that relates to the contextual information and that is consistent with the profile data (e.g., based on a determined linkage between media content and indication(s) in the contextual information and indication(s) in the profile data). In various embodiments, the immersive content platform 202 may analyze the contextual information and the profile data, and perform a comparison/match thereof with external data relating to media content (e.g., metadata, notes, archives, or other information) to identify and/or retrieve relevant media content.

As one example, in a case where the contextual information (e.g., location data) indicates that the user is located at, or is approaching or located proximate to (e.g., within a threshold distance from), a particular landmark (e.g., the Empire State Building), and where the profile data indicates that the user has an affinity for a particular character (e.g., a fictional character, such as Superman), the immersive content platform 202 may identify and/or retrieve media content that involves the particular landmark and the particular character (e.g., a reenactment of a scene from a film in which Superman flew by the Empire State Building).

As another example, in a case where the contextual information (e.g., location data, data regarding a present time of day, etc.) indicates that it is a suitable time for the user to consume a meal (e.g., noontime, etc.) and that the user is lingering or located at, or is approaching or located proximate to (e.g., within a threshold distance from), a particular restaurant (e.g., in Little Italy, New York City), and where the profile data indicates that the user has an affinity for a particular person (e.g., a celebrity, such as Frank Sinatra) associated with the particular restaurant, the immersive content platform 202 may identify and/or retrieve media content that involves the particular restaurant and the particular person (e.g., a 3D representation of Frank Sinatra at or near the restaurant).

As a further example, in a case where the contextual information includes a voice-based input from the user that identifies a person, a place, a thing, an event, etc., such as an utterance of a name of a location or establishment (e.g., “Rudy's,” “Max's Kansas City,” “Copacabana,” etc.), a name or title of an historical event (e.g., “Woodstock,” etc.), or the like, the immersive content platform 202 may map to, or otherwise identify and retrieve, media content, such as songs, images, videos, etc. associated with the named person, place, thing, or event.

It is to be appreciated and understood that numerous examples abound. For instance, other examples (depicted in FIGS. 2B-2D) may include the immersive content platform 202 identifying and/or retrieving media content relating to a famous dance performance (e.g., FIG. 2B) based on determining, from contextual information, that the user is located at or near (e.g., within a threshold distance from) Central Park, New York City and determining, from the user's profile data, that the user has a preference for romantic comedies and/or a dancing program (e.g., Dancing with the Stars or the like); the immersive content platform 202 identifying and/or retrieving media content relating to a (e.g., historical) Thanksgiving parade (e.g., FIG. 2C) based on determining, from contextual information, that the user is located at or near (e.g., within a threshold distance from) a Macy's store and determining, from the user's profile data, that the user has a preference for a certain musical artist, a certain music genre, etc.; and the immersive content platform 202 identifying and/or retrieving entertainment, informational, educational, demonstrational, and/or promotional content, such as cultural music, product brochures, ad placements, etc. (e.g., FIG. 2D) to present to the user, based on determining, from contextual information (e.g., an itinerary or the like relating to a current context and/or a future context), that the user is at the airport and en route to a vacation destination and based on determining, from the user's profile data, the user's interests, advertising preferences, etc.

As yet another example, in a case where the contextual information (e.g., location data) indicates that the user is located at, or is approaching or located proximate to (e.g., within a threshold distance from), a shopping mall, and where the profile data (e.g., social profile information) indicates that the user prefers a particular brand of products (e.g., has “liked” the particular brand) or that a particular person that the user is following on social media prefers (or has “liked”) the particular brand, the immersive content platform 202 may identify and/or generate navigation information (e.g., in the form of directional arrows and/or guided paths) to present to the user to guide the user to a store in the shopping mall that sells the particular brand of products.

As a further example, in a case where the contextual information (e.g., location data) indicates that the user is located at, or is approaching or located proximate to (e.g., within a threshold distance from), a particular restaurant, and where the profile data (e.g., social profile information) indicates that a particular person that the user is following on social media has previously “checked-in” at the particular restaurant, the immersive content platform 202 may identify and/or generate information regarding the particular restaurant to present to the user.

In various embodiments, in a case where the immersive content platform 202 is unable to identify (and/or retrieve) media content that relates to the contextual information and to the profile data associated with the user, the immersive content platform 202 may identify (and/or retrieve) other media content that relates to the contextual information, but not to the profile data, or alternatively, may identify (and/or retrieve) other media content that relates to the profile data, but not the contextual information.

As shown by reference number 220, the immersive content platform 202 may derive, from the media content, personalized media content based on the profile data.

In various embodiments, the immersive content platform 202 may generate personalized media content by defining, adapting, or adjusting one or more aspects or parameters of identified media content or objects within the identified media content. As one example, the immersive content platform 202 may define or adjust one or more audio characteristics of one or more portions of a video or audio clip (e.g., amplitude, frequency, etc.) and/or replace audio (e.g., by substituting a particular song originally presented during a Thanksgiving parade with a different song that the user's profile data indicates that the user has an affinity for). As another example, the immersive content platform 202 may define or adjust one or more visual characteristics of one or more frames of a video clip (e.g., brightness, contrast, color, etc.).

As yet another example, the immersive content platform 202 may define or adjust an appearance (e.g., tone, nature, etc.) of, or one or more visual characteristics of, an immersion environment or objects (e.g., AR objects or the like) to be included in the immersion environment. Continuing this example, the immersive content platform 202 may modify an appearance of a character in a film or television show scene, such as by substituting a shirt worn by the character for a shirt of a brand that the user recently searched for on the Internet and/or clicked through in an advertisement, substituting a shoe worn by the character with a shoe that the user previously observed at a store and uttered “this shoe looks nice,” and/or the like. Further continuing the example, the immersive content platform 202 may replace an original character in a film or television show scene with a 3D virtual representation of a different person, such as by substituting an original cast member in the television show “Friends” with a 3D virtual representation of the user or someone associated with the user (e.g., a friend, family member, etc.).

As another example, in a case where the immersive content platform 202 identifies and/or generates navigation information—e.g., to present to the user to guide the user to a store in the shopping mall that sells the user's preferred brand of products, the immersive content platform 202 may generate the navigation information to include a 3D rendering of a character (e.g., for which the user may have a determined affinity, such as Mickey Mouse, Spiderman, etc.) for guiding the user to the store.

In one or more embodiments, the immersive content platform 202 may include advertising content, such as AR object(s) of brands and/or products, in an immersion (e.g., whether for purposes of direct or indirect marketing to a user).

In various embodiments, the immersive content platform 202 may be configured to align media content with existing immersion environment/scene constraints (e.g., in XR) and/or presence of real-world objects, including, for example, by positioning AR objects behind physical real-world objects (e.g., occlusion) and/or the like.

In various embodiments, the immersive content platform 202 may implement or enable user interactivity in an immersion by generating, or otherwise including, triggers that, upon being activated or engaged by a user, may cause the immersive content platform 202 to perform adjustments to the media content and/or to obtain and provide other (e.g., related) media content in an immersion. Numerous types of triggers in various immersion contexts are possible. For example, in a case where the immersive content platform 202 generates a 3D representation of a character for guiding a user to a particular location, the immersive content platform 202 may enable triggering of, or user interaction with, the 3D representation—e.g., speaking in a direction toward the 3D representation may cause the 3D representation to respond (e.g., speak back, turn its head, etc.); touching of the 3D representation may cause the 3D representation to traverse several steps towards the particular location; and so on.

In some embodiments, the immersive content platform 202 may provide an interactive, automated response mechanism (e.g., a chat-bot or the like) configured to respond to detected user inputs (e.g., speech, movements, etc.) and/or guide a user through one or more triggers that are available in an immersion. For example, in a case where the immersive content platform 202 generates a 3D representation of a character for guiding a user to a particular location, the automated response mechanism may, based upon detecting user movement toward the 3D representation, entice the user (e.g., visually, audibly, etc.) to move closer to the 3D representation to cause the 3D representation to perform an action (e.g., to jump, to dance, to proceed several steps in a direction towards the particular location, etc.). In certain embodiments, the immersive content platform 202 may simply provide informational notifications relating to triggers to make users aware of such triggers. For example, in a case where the immersive content platform 202 provides a particular song to be played back in an immersion, the immersive content platform 202 may include an icon/object corresponding to the particular song and/or an instruction to a user to tap the object/icon for details regarding the particular song.

In various embodiments, the immersive content platform 202 may provide opportunities for new content generation. For example, a content creator may define triggers in media content that, upon selection or activation in an immersion, links to new media content and/or immersive experiences (e.g., similar to hidden or cut scenes of a film). In some embodiments, the immersive content platform 202 may leverage existing standards/protocols/frameworks (e.g., Moving Picture Experts Group (MPEG)-based standards, the Universal Scene Description (USD) framework, etc.) to facilitate conveyance or delivery of such new media content and/or immersive experiences.

In some embodiments, the immersive content platform 202 may define or adjust content based on demographic data associated with the user. For example, in a case where the user is a child and is exploring a museum exhibit, and where the immersive content platform 202 identifies the exhibit (e.g., according to the child's detected location, facial recognition data from one or more nearby cameras, an utterance by the child or a person nearby identifying the exhibit, etc.) and obtains media content associated with the exhibit, such as a predefined introduction/section/object label describing the exhibit, the immersive content platform 202 may generate a shortened or simplified version of the label for the child. Continuing the example, the immersive content platform 202 may analyze the content of the predefined introduction/section/object label and derive, based on the analysis, a summary of the content using words determined to be suitable for the child to comprehend.

In various embodiments, the immersive content platform 202 may identify and/or obtain media content associated with activities of other user(s) who have previously engaged in an immersion at the particular location (e.g., music, a soundscape, a video, or the like that other user(s) have experienced at the particular location (and, for example, were determined to have reacted positively to); dances that other user(s) have performed while experiencing an immersion at the particular location; etc.), and may include such media content in the immersion for the user to consume/experience.

In some embodiments, the immersive content platform 202 may customize an immersion environment with background audio to provide a more entertaining immersive experience for the user. For example, the immersive content platform 202 may include, in an immersion, a particular song that the user tends to repeat on the user's playlist, a piece of music that aligns with a determined present mood of the user, or the like. In certain embodiments, the immersive content platform 202 may generate, provide, or otherwise facilitate, gameplay relating to media content presented in an immersion environment, such as a trivia game relating to a song or a video being played back, etc., which can further enrich a user's immersive experience.

In exemplary embodiments, the immersive content platform 202 may identify media content and/or generate personalized media content based on network conditions and/or the availability/capabilities of presentation (e.g., display) devices, such as the target device(s) 204, that are accessible, or located proximate, to the user. In some embodiments, the immersive content platform 202 may employ traffic/device discovery techniques for determining network conditions and/or identifying availability of target device(s) 204. In various embodiments, the immersive content platform 202 may have universal client platform support, and may normalize and/or adapt immersions across a variety of devices and platforms (e.g., user devices, proximal displays, rendering platforms (e.g., of various protocols, such as OpenXR or the like), etc.). In certain embodiments, the immersive content platform 202 may be configured to select the appropriate manner of presentation of media content (e.g., by employing one or more “casting” technologies) across target device(s). For example, the immersive content platform 202 may provide 3D media content to 3D glasses that support 3D content, may provide 2D media content to a 2D display, etc.

In various embodiments, the immersive content platform 202 may identify, based on a location of the user, target device(s) 204 that are available for use at or proximate to the location. In one or more embodiments, the immersive content platform 202 may identify target device(s) 204 upon start-up, such as when the user initiates a connection to the immersive content platform 202 with the user's smartphone, XR gear, or the like. In some embodiments, a provider of the immersive content platform 202 may have access to target device(s), such as video/audio output devices (e.g., digital displays (e.g., televisions, jumbotrons, or the like), speakers, etc.) positioned at various locations. For example, the provider of the immersive content platform 202 may have access to target device(s) that are available as part of the provider's own inventory of target device(s), available as part of the user's personal environment (e.g., displays accessible via a smartphone, a home network, a vehicle, or the like), or available as part of a prior arrangement that the provider has with one or more third parties that own or manage target device(s) (e.g., a display, a speaker, or the like located at a physical establishment, such as a brick-and-mortar store, a museum, etc.). In certain embodiments, the immersive content platform 202 may access, or otherwise obtain, information regarding such target device(s), such as a location of a target device, an orientation of a target device (e.g., which direction a display device is facing or the like), capability data (e.g., display resolution, audio-related specifications, etc.), and/or the like, and may identify, generate, and/or provide media content in an immersion for a user based on such target device information.

For example, in a case where the immersive content platform 202 identifies high definition video content (e.g., 4K or the like) or 3D (or XR) media content, but determines that available target device(s) 204 lack the capability to render such content and/or that network conditions are poor (e.g., where available bandwidth satisfies a threshold or the like), the immersive content platform 202 may adjust a quality of the content, or otherwise adapt the content to a less computationally-intensive version of the content, to suit the network conditions and/or the capabilities of the available target device(s) 204. Continuing the example, the immersive content platform 202 may decrease a resolution of the video content, generate a 2D version of 3D media content, or the like.

Identifying, generating, and/or providing media content in an immersion for a user based on target device availability and/or capabilities can also aid the immersive content platform 202 in filtering or narrowing down the media content to obtain (or retrieve) and present to the user, particularly in a case where the immersive content platform 202 identifies numerous relevant media content that matches the contextual information and/or the user's profile data. For example, in a case where the immersive content platform 202 determines that available target device(s) 204 lack display capabilities and/or that network conditions are poor (e.g., where available bandwidth satisfies a threshold or the like), the immersive content platform 202 may select and retrieve text-based content (e.g., only text-based content) or audio-based media content (e.g., only audio-based media content), such as audio-based informational content, podcasts, announcements, etc., to present to the user.

In various embodiments, the immersive content platform 202 may identify different media content and/or generate different personalized media content for different available target device(s) 204 to render or present, based on the capabilities of the different target device(s) 204, orientations of the different target device(s) 204, etc. so as to provide a more realistic and enjoyable immersive experience for the user. For example, in a case where the immersive content platform 202 determines that a first display device is oriented towards where the user is located and a second display device is oriented away from where the user is located, the immersive content platform 202 may identify, generate, and/or provide media content for the first display device to present and not for the second display device to present. As another example, in a case where the immersive content platform 202 determines that a first speaker device and a second speaker device are positioned and oriented, relative to where a user is located, to provide a suitable audible effect (e.g., surround sound or the like), but that a third speaker device is positioned too far away (e.g., beyond a threshold distance) from the user and/or is oriented away from where the user is located, the immersive content platform 202 may identify, generate, and/or provide media content for the first speaker device and the second speaker device to present and not for the third speaker device to present.

In various embodiments, the immersive content platform 202 may additionally, or alternatively, define or adjust how media content (or an overall immersion) is to be rendered based on environmental factors or obstacles (e.g., local weather, local time of day, lighting, presence of potential obstacles proximate to the user for occlusion purposes, etc., as may be identified in available data, such as from local information sources, image/video data captured and provided by nearby cameras (e.g., IoT cameras, etc.), and/or the like) so as to provide a more realistic and enjoyable immersive experience for the user. For example, the immersive content platform 202 may augment or define how an immersion is to be rendered by adjusting a brightness, a contrast, or a color of graphical objects in media content, by adjusting volume, signal properties, etc. of audio elements in media content, and/or the like, depending on surface planes of nearby obstacles, available environmental lighting, etc.

In some embodiments, the immersive content platform 202 may rank or score available media content, and select media content to present to the user based on the rankings or scores, which can aid the immersive content platform 202 in determining which media content to present to the user, particularly in a case where the immersive content platform 202 identifies numerous relevant media content that matches the contextual information and/or the user's profile data. In certain embodiments, the immersive content platform 202 may rank media content based on a determined level of user affinity relating to a given media content (e.g., where a higher ranking may be assigned to a first media content item (e.g., relating to Spiderman) than to a second media content item (e.g., relating to Micky Mouse) based on there being more indications in the user's profile data relating to the first media content item (e.g., more user search queries relating to Spiderman, more instances of prior user consumption of content relating to Spiderman, etc.)). In one or more embodiments, the immersive content platform 202 may rank media content based on recency of user affinity relating to a given media content (e.g., where a higher ranking may be assigned to a first media content item (e.g., song(s) by a first music artist) than to a second media content item (e.g., song(s) by a second music artist) based on indications in the user's profile data of recent activity relating to the first media content item (e.g., recent user consumption of song(s) by the first music artist, etc.) and, optionally, despite indications in the user's profile of higher levels or more instances of past activity relating to the second media content item). In some embodiments, the immersive content platform 202 may rank media content based on advertising or marketing opportunities (e.g., where a higher ranking may be assigned to a first media content item (e.g., relating to, or that can be adapted to include a visual of, a brand of sneakers that can be advertised to the user) than to a second media content item (e.g., not relating to, or that cannot be properly adapted to include a visual of, the brand of sneakers)).

In various embodiments, the immersive content platform 202 may be communicatively coupled with one or more ad tech systems (including, e.g., bidding system(s), etc.) that facilitate real-time auction(s), where line items or predetermined requirements are utilized, such as in conjunction with user affinity information identified in user profile data, to facilitate delivery of advertising in immersions.

As shown by reference number 225, the immersive content platform 202 may cause the target device(s) to render/provide an immersion environment that includes the personalized media content.

In various embodiments, the immersive content platform 202 may provide different portions of the immersion data to different ones of the target device(s) 204 to render so as to provide a (e.g., fully) immersive experience for the user. For example, in a case where the generated personalized media content includes XR elements/objects, high definition audio content, etc., the immersive content platform 202 may provide the XR elements/objects to one or more available target device(s) 204 that are capable of rendering XR content, may provide the high definition audio content to one or more available target device(s) 204 that are capable of rendering/providing such audio content, etc.

As shown by reference number 230, the immersive content platform 202 may detect user interaction data.

In various embodiments, the immersive content platform 202 may obtain user interaction data from one or more of the target device(s) 204 based upon user interactions with personalized media content rendered by the one or more target device(s) 204. User interactions can include gestures (e.g., hand- or finger-based selections or movements), utterances or other voice-based commands, etc. relative to the rendered content. In some embodiments, the immersive content platform 202 may obtain other data relating to user movements (e.g., position data, such as gyroscope data, provided by a user's smartphone, smartwatch, or the like; image/video data associated with the user captured and provided by nearby cameras (e.g., IoT cameras); etc.), such as dance-related movements (e.g., swaying, rocking, or the like of the user's body, such as the arms, shoulders, hips, legs, etc.) or the like.

For example, in a case where the immersive content platform 202 identifies and/or retrieves media content relating to a (e.g., historical) Thanksgiving parade (e.g., FIG. 2C) based on determining, from contextual information, that the user is located at or near (e.g., within a threshold distance from) a Macy's store, and based on determining, from the user's profile data, that the user has a preference for a particular music artist and/or a preference for a particular brand of clothing, and where the immersive content platform 202 personalizes the media content to include a particular song by the music artist during rendering of the parade and/or to substitute a shirt worn by a character/person in the parade with a shirt of the user's preferred brand, the immersive content platform 202 may obtain user interaction data associated with, for example, the user touching the particular branded shirt worn by the 3D avatar of the person/character in the parade, the user uttering that the user likes the song being played back during the parade, and/or the like.

As shown by reference number 235, the immersive content platform 202 may perform an action relating to the personalized media content based on the user interaction data.

In various embodiments, the immersive content platform 202 may store (or catalog) the user interaction data. In some embodiments, the immersive content platform 202 may enable a user to bookmark, add to a playlist, or otherwise record, an immersion and/or user interaction data therein for future playback. For example, in a case where the user utters that the user likes a song that is being played back during an immersion or where the user manually selects a rendered object corresponding to the song (such as a 3D music symbol icon/object presented in the immersion and corresponding to the song), the immersive content platform 202 may cause the song to be added to the user's personal playlist. As another example, in a case where the user performed a dance during an immersion, the immersive content platform 202 may store data relating to the user's dance moves in the user's library (or archive) of personal content or in a library of content associated with the present location of the user. This enables replaying of the user interaction/activity at a later time and/or sharing of the immersion and/or user interaction data with other users, and may allow other user to view/experience the user's immersion interactions at the location. In a case where a first user's immersion-related dancing is recorded and later retrieved and replayed in a different immersion for a second user, the immersive content platform 202 may generate an avatar that has a visual appearance (likeness) of the first user and dance moves corresponding to the recorded dancing. In some embodiments, and to promote social engagement, the immersive content platform 202 may, based upon identifying, retrieving, and/or using the first user's user interaction data—e.g., dance recording—in an immersion for another user, provide a notification to the first user (e.g., to the first user's smartphone or the like) that the other user is viewing the first user's dance.

In various embodiments, the immersive content platform 202 may initiate a (e.g., real world) transaction, such as a purchase request or the like, based on user interaction data, which can enhance the user's overall immersive experience and/or broaden marketing channels. For example, in a case where the user touches a particular item (e.g., a branded shirt, a meal, etc.) in an immersion, the immersive content platform 202 may cause the item (e.g., shirt) to be added to the user's virtual shopping cart and/or facilitate a purchase or order of the item (e.g., shirt, meal, etc.) with a local merchant nearby and/or over the Internet. As another example, in a case where the immersive content platform 202 determines that the user has a preference for a particular brand (e.g., a particular coffee brand), the immersive content platform 202 may identify, generate, and/or provide media content involving characters consuming a product of that particular brand, and may (e.g., either without detecting any user interaction data in the immersion or, alternatively, based upon detecting user interaction in the immersion, such as an utterance of “I want some coffee now” or the like) cause one or more offers for products of that particular brand to be provided to the user. Continuing the example, the immersive content platform 202 may cause the one or more offers to be provided to the user via a text message, via e-mail, by adding a product of that particular brand to the user's virtual shopping cart, by placing an order for a product of that particular brand at a nearby store, and/or the like.

In various embodiments, the immersive content platform 202 may generate, and cause the target device(s) 204 to present, data or content associated with additional follow-up activities relating to a particular location. For example, in a case where a user has experienced an immersion at a particular location, and historical data of other users who have visited the particular location (e.g., archives of other users' immersion-related interaction data associated with the particular location, other users' social media posts, and/or the like) indicates that the other users have typically subsequently visited a proximal location (e.g., an ice cream shop, a restaurant, etc.) after experiencing an immersion at the particular location, the immersive content platform 202 may generate, and cause one or more of the target device(s) 204 to present, a recommendation or navigation information to guide the user to such a “next” proximal location.

In various embodiments, the immersive content platform 202 may facilitate follow-up activities and/or interactions in the physical world, such as via IoT systems, point-of-sale systems, or the like. For example, in a case where the above-described “next” proximal location is a service-based establishment, such as an ice cream shop, a restaurant, etc., the immersive content platform 202 may, based upon user confirmation, time of data, calendar data of the user, user preferences in the user's profile data, etc., place a reservation for the user at the “next” proximal location.

As another example, the immersive content platform 202 can automatically schedule a particular appointment for the user (e.g., based on an immersion including media content relating to dentistry and based on the user's calendar data indicating that the user is past due for dental cleaning, etc.), set a reminder for the user to complete a task, prepare and/or submit a social media post to “check-in,” and/or the like.

In various embodiments, the immersive content platform 202 may provide, to other users (e.g., other users located at or proximate to the user's location or other users that may not be located at or proximate to the user's location, but that may be within the user's social circle), a notification regarding (and/or an invite to participate in) the immersion being provided for the user, which may promote additional user engagement/interaction relating to the immersion.

In various embodiments, the immersive content platform 202 may modify an immersion (e.g., in real-time or near real-time) based upon detecting user movement or reactions (e.g., gazing, walking, running, slowing down, stopping movement, etc.) during the immersion, user interaction with media content in the immersion (e.g., selections of objects, utterances, etc.), user engagement with one or more other users also experiencing the immersion, etc. For example, the immersive content platform 202 may modify an immersion by adjusting a scene (e.g., graphics) of the immersion as the user moves about, turns around, or the like; by switching playback of certain portions of media content between different target device(s) as the user moves about, turns around, or the like; and/or by removing or adding additional media content to the immersion, such as based upon detecting user movements, gestures, commands, utterances, etc. (which enables in-painting of the immersion, such as by adding a virtual basketball hoop object in response to the user performing movements indicative of a basketball shooting motion and/or the like). As another example, the immersive content platform 202 may, based upon detecting a low level of user engagement (e.g., inattentiveness and/or the like) in an immersion, determine that lower quality media content (e.g., audio-only content or low resolution video rather than 4K video) can be presented to the user, and may adjust presentation of the immersion accordingly, which can conserve computing resources and network resources, thereby improving overall system and network performance.

In various embodiments, the immersive content platform 202 may modify an immersion (e.g., in real-time or near real-time) according to a (e.g., predicted) mood or sentiment of the user, which may be determined based upon the user's voice-based inputs, based upon the user's gesture-based inputs, and/or based upon content that the user typically consumes during certain activities and/or during certain times of day, such as during workouts in the morning, during the evening after dinner, and/or the like. In some embodiments, the immersive content platform 202 may alter media content in an immersion to improve the user's mood, such as by causing certain media content to be presented. For example, the immersive content platform 202 may cause a Christmas special to be presented in an immersion to cheer the user up. As another example, the immersive content platform 202 may include, in an immersion, audio and/or video content that might not be part of an original media content, but that may improve the user's mood, such as a jolly song during presentation of an otherwise neutral immersion experience.

In various embodiments, the immersive content platform 202 may generate personalized media content to include trigger(s) that coax, or otherwise entice, a user to perform an action. For example, in a case where the immersive content platform 202 determines that it is a suitable time for the user to consume a meal (e.g., noontime or the like), identifies a marketing opportunity involving a restaurant within walking distance from the user's current location, and identifies that the user has an affinity for a particular person (e.g., a celebrity, such as Frank Sinatra), the immersive content platform 202 may identify and/or define media content that includes an interactive 3D avatar or representation of the celebrity configured to guide the user to the restaurant.

In some cases, XR content creators or authors may enable puppeteering of character(s) in media content—e.g., by enabling a character to be replaced (or substituted) with a 3D avatar having a present user's likeness and/or by enabling a character to mimic or otherwise exhibit actions of the present user. In such cases, the immersive content platform 202 may modify an immersion by controlling a visual appearance and/or movements of one or more characters in an immersion based on the present user's movements (e.g., dance moves), speech, manner of speech, etc.

In some cases, XR content creators or authors may enable pre-splitting of dialog points for user interaction—e.g., to allow a user to pick up acting within a scene, such as speaking a line intended to be spoken by an original character, but where the user's speaking of the line triggers the scene to begin/continue.

In various embodiments, the immersive content platform 202 can employ machine learning algorithm(s) that are configured to learn a user's behavior or preferences relating to interactive, personalized media content experiences (including, e.g., immersive experiences). This can include, for example, the user's reactions (e.g., selections, movements, utterances, etc.) relating to presented media content, the user's preferences for objects (e.g., AR objects, etc.), storylines, etc. in media content, and/or the like. In various embodiments, the immersive content platform 202 may adjust, based on the learned information, future actions performed by, or outputs provided by, the immersive content platform 202 to enhance the user's immersive experiences. For example, in some embodiments, the immersive content platform 202 may provide information regarding a user's preferences or behavior as input to one or more machine learning algorithms, which may perform machine learning to automate future determinations or predictions of user preferences or behavior. For instance, the immersive content platform 202 may train a machine learning algorithm based on known inputs (e.g., identified, generated, and/or provided media content) and known outputs (e.g., the user engaging, such as moving toward, reaching out for, touching, etc., an AR object in an immersion, but not engaging other media content in the immersion; the user uttering positive phrases (e.g., “wow,” “I like that,” etc.) in relation to some media content in an immersion, but uttering negative phrases (e.g., “I don't like that,” etc.) in relation to other media content; etc.).

In some embodiments, the immersive content platform 202 may refine a machine learning algorithm based on feedback received from a user of the immersive content platform 202 and/or from one or more other devices (e.g., management device(s)). For example, the user of the immersive content platform 202 and/or one or more management devices may provide feedback indicating whether predictions of user preferences or behavior, made by the machine learning algorithm based on new inputs, are accurate and/or helpful. When the feedback indicates that a particular prediction is accurate and/or helpful, the immersive content platform 202 may configure the machine learning algorithm to make predictions of user preferences or behavior based on the particular prediction (e.g., to predict user preferences or behavior in a manner similar to that in which the particular prediction was made). When the feedback indicates that a particular prediction is not accurate or helpful, the immersive content platform 202 may configure the machine learning algorithm to avoid predicting user preferences or behavior in a manner in which the particular prediction was made. In this way, the immersive content platform 202 can predict user preferences or behavior based on one or more machine learning algorithms, which improves the accuracy of the predictions, and conserves processor and/or storage resources that may otherwise be used to generate and store rules for predicting user preferences or behavior.

FIG. 2E is a high-level functional block diagram of a system 270 functioning within, or operatively overlaid upon, the communications network of FIG. 1 in accordance with various aspects described herein. In various embodiments, the system 270 may be similar to the system 200 and/or the immersive content platform 202 of FIG. 2A. For example, the system 270 may perform functions similar to those described above with respect to the immersive content platform 202, such as functions relating to identifying, generating, and/or providing of interactive, personalized media content based on contextual information and user profile data. In various embodiments, the system 270 can (e.g., similar to that described above with respect to the immersive content platform 202 of FIG. 2A) be configured to obtain contextual information (270b) relating to a user (e.g., location data, data regarding a media content item that the user has requested or is currently consuming, calendar data, travel-related data, voice-based input data associated with the user, gesture-based input data associated with the user, time of day information, weather information, etc.), and identify media content (e.g., audio content, image content, video content, XR objects, etc.) (270d) that relates to the contextual information and to profile data (270a) associated with the user (e.g., information regarding preferences of the user, interests of the user, a browsing history of the user, a media consumption history of the user, a purchase history of the user, an advertising response history of the user, historical immersion-related behavior of the user, etc.). In some embodiments, the system 270 may derive, from the media content, personalized media content based on the profile data, and cause one or more target device(s) (e.g., a smartphone, a smartwatch, an XR-based user equipment, and/or one or more proximal devices, such as proximal displays, proximal speakers, etc.) (270c) to provide an immersion environment that includes the personalized media content.

In one or more embodiments, the system 270 may include a rendering/re-creation engine 270e configured to generate immersion data, that includes the personalized media content, for the target device(s) to render. For example, the system 270 may (e.g., similar to that described above with respect to the immersive content platform 202 of FIG. 2A) generate immersion data based on local time, weather, lighting, significant objects that are around the user, etc. (e.g., where lighting, sound, etc. of an immersion may be adjusted accordingly). As another example, the system 270 may (e.g., similar to that described above with respect to the immersive content platform 202 of FIG. 2A) generate immersion data based on hardware/system capabilities of the target device(s), bandwidth requirements of media content, etc. (e.g., where lower quality content may be presented on a less capable smartphone than a more capable proximal display device).

In various embodiments, the system 270 may (e.g., similar to that described above with respect to the immersive content platform 202 of FIG. 2A) have access to and/or identify content creator-provided triggers (270f and 270g), and combine, integrate, or otherwise include, such triggers with corresponding media content in an immersion to provide opportunities for new content generation and enhanced immersive experiences for users.

In certain embodiments, the system 270 may (e.g., similar to that described above with respect to the immersive content platform 202 of FIG. 2A) detect user interaction data (e.g., information regarding movements of the user, gesture-based inputs of the user, voice-based inputs of the user, etc.) (270c) relating to the immersion environment, and perform action(s) relating to the personalized media content based on the user interaction data. In some embodiments, the system 270 may interleave (e.g., using the rendering/re-creation engine 270e) real-time media content or assets (e.g., adapted based on user movements, adapted based on predicted user activities, and/or the like) with original or previously-rendered versions of the media content (including, e.g., by linking to such prior content or assets as needed) to provide a smooth or seamless immersive experience for the user, while, for example, maintaining a prior narrative in the media content. As an example, for interleaved rendering, a previously-created version of an immersion for a basketball team may have been created (e.g., a historical rendering) and may be served to the user, but the immersion may be rendered by the rendering/re-creation engine 270e with real-time, or near real-time, updates (e.g., featuring highlights or occasional updates from a game that is currently occurring) and/or timely, user-specific content (e.g., a visual of the user in a case where the user was previously present at a stadium and posed for a “fan-cam” or the like). In one or more embodiments, the system 270 may (e.g., optionally) leverage user interactions and/or proximal device scans (e.g., derived depth maps from hardware of target devices, such as target device(s) 204 of FIG. 2A) as rendering/interaction mechanisms. In one example, in a case where the user approaches a travel display at an airport (e.g., FIG. 2D), the rendering/re-creation engine 270e may provide, or otherwise (e.g., fully) encompass, the user with vacation-related content, such as beach visuals, sounds, a wayward sand crab near the user's feet, etc. Continuing the example, upon performing a device scan (e.g., using cameras included in, or associated with, the travel display for determining distance/depth to the user and the user's surroundings; using Bluetooth network monitoring to detect a nearby or adjacent device count; and/or the like) and identifying limits, restrictions, or constraints, the immersion may instead be rendered to include a distant island scene (e.g., not encompassing the user) and/or fewer/smaller renderings (e.g., sound of a seagull, a video of a waving palm tree, etc.) that are distributedly presented by various target devices 204 around the user.

In various embodiments, the system 270 may (e.g., similar to that described above with respect to the immersive content platform 202 of FIG. 2A) orchestrate (e.g., via a follow-up orchestrator 270h) one or more follow-up actions/activities, such as recording the personalized media content and/or the user interaction data (e.g., in a media content library associated with the user, in a general archive, and/or the like) for future playback, sharing the personalized media content and/or the user interaction data with one or more other users associated with the user, associating the personalized media content and/or the user interaction data with the location of the user for future use (e.g., in an immersion associated with a different user, etc.), facilitating a reservation for a service for the user, facilitating a purchase of a product for the user, scheduling a service appointment for the user, facilitating additional media location guidance (e.g., presenting data or content associated with additional follow-up activities at a subsequent location), etc.

It is to be understood and appreciated that, some or all of the aspects and/or functionalities of the system 200 may apply to, be included in, or be provided by the system 270. For example, some or all of the aspects and/or functionalities of the immersive content platform 202, described above with respect to FIG. 2A, may apply to, be included in, or be provided by the system 270.

It is also to be understood and appreciated that the quantity and arrangement of immersive content platforms, target devices, and networks shown in or described with respect to FIGS. 2A and 2E are provided as examples. In practice, there may be additional immersive content platforms, target devices, and networks, fewer immersive content platforms, target devices, and networks, or differently arranged immersive content platforms, target devices, and networks than those shown in or described with respect to FIGS. 2A and 2E. For example, the system 200 and/or 270 can include more or fewer immersive content platforms, target devices, and networks, etc. Furthermore, two or more immersive content platforms, target devices, and networks shown in or described with respect to one or more of FIGS. 2A and 2E may be implemented within a single immersive content platform, target device, and network, or a single immersive content platform, target device, and network shown in or described with respect to one or more of FIGS. 2A and 2E may be implemented as multiple, distributed immersive content platforms, target devices, and networks. Additionally, or alternatively, a set of immersive content platforms, target devices, and networks (e.g., one or more immersive content platforms, target devices, and networks) of the system 200 and/or 270 may perform one or more functions described as being performed by another set of immersive content platforms, target devices, and networks of the system 200 and/or 270.

FIG. 2F depicts an illustrative embodiment of a method 290 in accordance with various aspects described herein. In some embodiments, one or more process blocks of FIG. 2F can be performed by an immersive content platform, such as the immersive content platform 202 or the system 270. In some embodiments, one or more process blocks of FIG. 2F may be performed by another device or a group of devices separate from or including the immersive content platform, such as target devices (e.g., one or more of the target device(s) 204).

At 290a, the method can include obtaining contextual information relating to a user, where the contextual information comprises location data that identifies a location of the user. For example, the immersive content platform 202 or the system 270 can obtain contextual information relating to a user in a manner similar to that described above with respect to the system 200 of FIG. 2A or the system 270 of FIG. 2E, where the contextual information comprises location data that identifies a location of the user.

At 290b, the method can include identifying media content that relates to the contextual information and to profile data associated with the user. For example, the immersive content platform 202 or the system 270 can identify media content that relates to the contextual information and to profile data associated with the user in a manner similar to that described above with respect to the system 200 of FIG. 2A or the system 270 of FIG. 2E.

At 290c, the method can include deriving, from the media content, personalized media content based on the profile data associated with the user. For example, the immersive content platform 202 or the system 270 can derive, from the media content, personalized media content based on the profile data associated with the user in a manner similar to that described above with respect to the system 200 of FIG. 2A or the system 270 of FIG. 2E.

At 290d, the method can include causing a target device to provide an immersion environment that includes the personalized media content. For example, the immersive content platform 202 or the system 270 can cause a target device to provide an immersion environment that includes the personalized media content in a manner similar to that described above with respect to the system 200 of FIG. 2A or the system 270 of FIG. 2E.

At 290e, the method can include detecting user interaction data relating to the immersion environment. For example, the immersive content platform 202 or the system 270 can detect user interaction data relating to the immersion environment in a manner similar to that described above with respect to the system 200 of FIG. 2A or the system 270 of FIG. 2E.

At 290f, the method can include performing an action relating to the personalized media content based on the detecting the user interaction data. For example, the immersive content platform 202 or the system 270 can perform an action relating to the personalized media content based on the detecting the user interaction data in a manner similar to that described above with respect to the system 200 of FIG. 2A or the system 270 of FIG. 2E.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

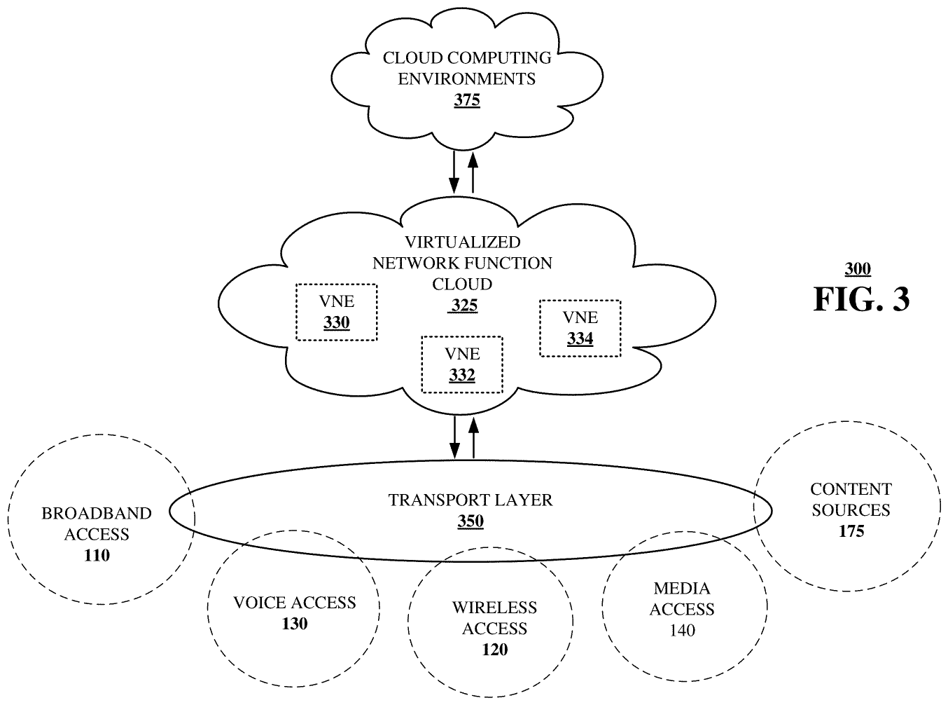

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, system 270, and method 290 presented in FIGS. 1, 2A, 2E, and 3. For example, virtualized communications network 300 can facilitate, in whole or in part, identifying, generating, and/or providing of interactive, personalized media content based on contextual information and user profile data.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

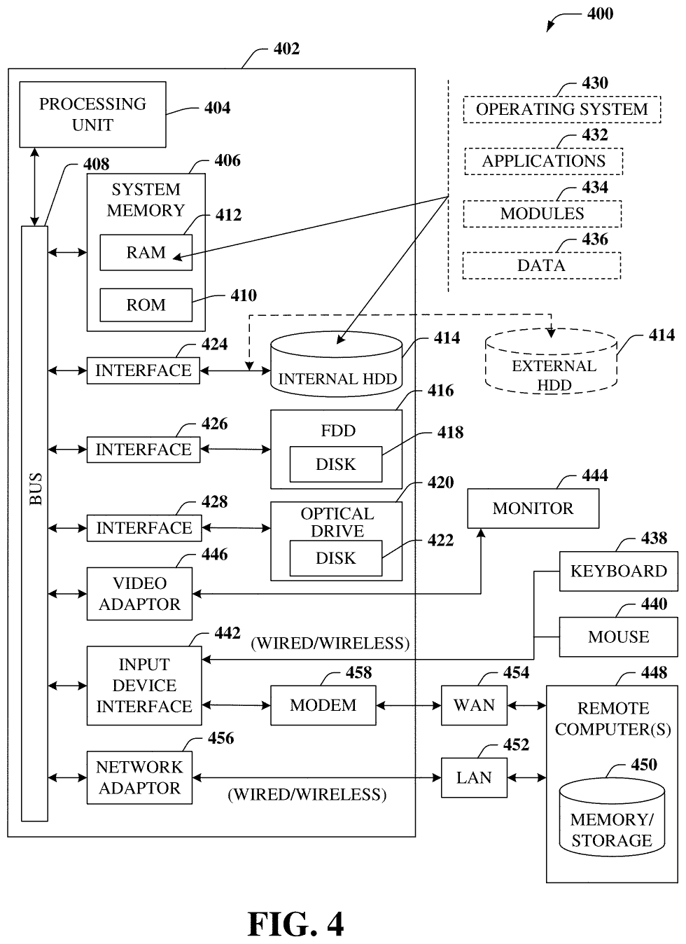

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, identifying, generating, and/or providing of interactive, personalized media content based on contextual information and user profile data.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

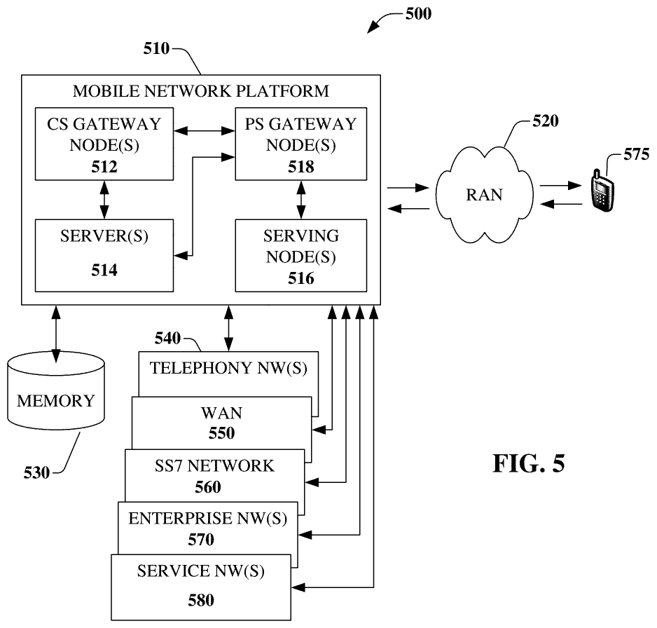

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, identifying, generating, and/or providing of interactive, personalized media content based on contextual information and user profile data. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

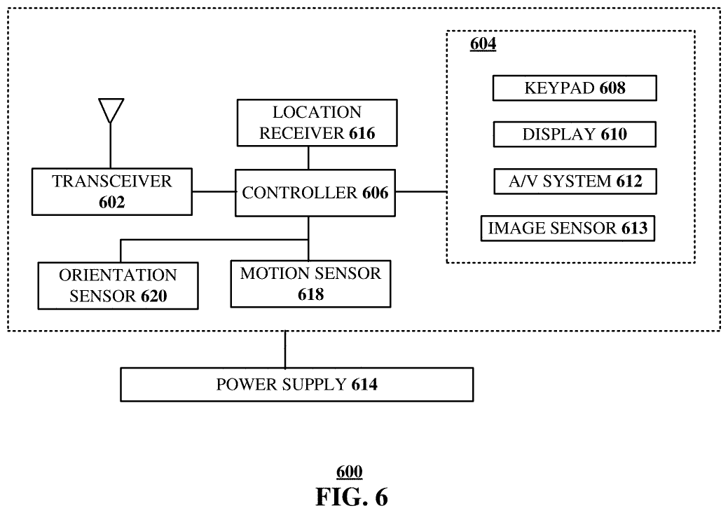

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate, in whole or in part, identifying, generating, and/or providing of interactive, personalized media content based on contextual information and user profile data.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining contextual information relating to a user, wherein the contextual information comprises location data that identifies a location of the user;
identifying media content that relates to the contextual information and to profile data associated with the user;
deriving, from the media content, personalized media content based on the profile data associated with the user;
causing a target device to provide an immersion environment that includes the personalized media content;
detecting user interaction data relating to the immersion environment; and
performing an action relating to the personalized media content based on the detecting the user interaction data.

2. The device of claim 1, wherein the contextual information further comprises data regarding a media content item that the user has requested or is currently consuming, calendar data associated with the user, travel-related data associated with the user, voice-based input data associated with the user, gesture-based input data associated with the user, time of day information, weather information, or a combination thereof.

3. The device of claim 1, wherein the profile data comprises information regarding preferences of the user, interests of the user, a browsing history of the user, a media consumption history of the user, a purchase history of the user, an advertising response history of the user, historical immersion-related behavior of the user, or a combination thereof.

4. The device of claim 1, wherein the media content comprises audio content, image content, video content, one or more extended reality (XR) objects, or a combination thereof.

5. The device of claim 1, wherein the operations further comprise identifying an advertising opportunity based on the profile data, and wherein the deriving the personalized media content comprises adapting the media content to include a representation of a product associated with the advertising opportunity.

6. The device of claim 1, wherein the user interaction data comprises information regarding a movement of the user, information regarding a gesture of the user, information regarding speech output by the user, or a combination thereof.

7. The device of claim 1, wherein the operations further comprise generating immersion data that includes the personalized media content, and transmitting the immersion data to the target device.

8. The device of claim 1, wherein the performing the action comprises recording the personalized media content for future playback, recording the user interaction data for future playback, sharing the personalized media content with one or more other users associated with the user, sharing the user interaction data with one or more other users associated with the user, associating the user interaction data with the location of the user for future use in an immersion associated with a different user, facilitating a reservation for a service for the user, facilitating a purchase of a product for the user, scheduling a service appointment for the user, or a combination thereof.

9. The device of claim 1, wherein the personalized media content comprises an interactive virtual representation of a person or character for which the profile data indicates that the user has an affinity, wherein the user interaction data relates to user movements or speech, and wherein the performing the action comprises determining, according to the user movements or speech, a modification to be made to the interactive virtual representation of the person or character, and causing the target device to adjust the interactive virtual representation of the person or character in the immersion environment based on the modification.

10. The device of claim 1, wherein the causing the target device to provide the immersion environment comprises causing the target device to provide the immersion environment based on environmental factors or obstacles associated with the location.

11. A non-transitory machine-readable medium, comprising executable instructions that, when executed by a processing system including a processor, facilitate performance of operations, the operations comprising:
providing, to an immersive content platform, contextual information relating to a user, wherein the contextual information comprises location data that identifies a location of the user;
responsive to the providing the contextual information to the immersive content platform, obtaining, from the immersive content platform, immersion data to be rendered, wherein the immersion data includes personalized media content derived according to profile data associated with the user;
rendering the immersion data to provide the personalized media content in an immersion environment;
detecting a user interaction relating to the immersion environment; and
based on the detecting the user interaction, transmitting user interaction data to the immersive content platform to enable the immersive content platform to perform a follow-up action relating to the personalized media content.

12. The non-transitory machine-readable medium of claim 11, wherein the contextual information further comprises data regarding a media content item that the user has requested or is currently consuming, calendar data associated with the user, travel-related data associated with the user, voice-based input data associated with the user, gesture-based input data associated with the user, time of day information, weather information, or a combination thereof.

13. The non-transitory machine-readable medium of claim 11, wherein the profile data comprises information regarding preferences of the user, interests of the user, a browsing history of the user, a media consumption history of the user, a purchase history of the user, an advertising response history of the user, historical immersion-related behavior of the user, or a combination thereof.

14. The non-transitory machine-readable medium of claim 11, wherein the media content comprises audio content, image content, video content, one or more extended reality (XR) objects, or a combination thereof.

15. The non-transitory machine-readable medium of claim 11, wherein the user interaction data comprises information regarding a movement of the user, information regarding a gesture of the user, information regarding speech output by the user, or a combination thereof.

16. A method, comprising:
receiving, by a processing system including a processor, contextual information regarding a user, wherein the contextual information comprises location data that identifies a location of the user;
identifying, by the processing system, media content that relates to the contextual information and to profile data associated with the user;
generating, by the processing system and from the media content, personalized media content adapted to promote user interaction;
causing, by the processing system, a plurality of target devices to provide an immersion environment that includes the personalized media content;
detecting, by the processing system, user interaction data relating to the immersion environment; and
based on the user interaction data, performing an action relating to the personalized media content.

17. The method of claim 16, wherein the personalized media content comprises an advertising object corresponding to a product to be marketed, wherein the user interaction data is associated with a user selection of the advertising object, and wherein the performing the action comprises facilitating a purchase of the product for the user.

18. The method of claim 16, wherein the personalized media content comprises an interactive virtual representation of a person or character, and is adapted to coax the user to move along with the interactive virtual representation of the person or character to a particular physical destination.

19. The method of claim 16, wherein the causing comprises causing a first target device of the plurality of target devices to provide a first portion of the immersion environment, and a second target device of the plurality of target devices to provide a second portion of the immersion environment.

20. The method of claim 19, wherein the first target device is associated with the user, and wherein the second target device is not associated with the user.
